(19) United States
(12) Patent Application Publication
(10) Pub. No.: US 2020/0165120 A1
(43) Pub. Date: May 28, 2020

(54) APPARATUS FOR DISPENSING A LIQUID

(71) Applicant: Alcon Inc., Fribourg (CH)

(72) Inventors: Jens Wolfstaedter, Kleinwallstadt (DE); Felix Brinckmann, Rossdorf (DE); Nils Schweizer, Bad Konig (DE); Alfred Fischer, Niedernberg (DE)

(21) Appl. No.: 16/694,377

(22) Filed: Nov. 25, 2019

Related U.S. Application Data
(60) Provisional application No. 62/772,216, filed on Nov. 28, 2018.

(51) Int. Cl. B67D 7/02; B67D 7/66; B67D 7/70; B67D 7/08; B65B 65/00; B65B 1/04; B65B 43/52; B65B 7/28; B65B 1/30; B65B 25/00

(52) U.S. Cl. CPC B67D 7/02; B67D 7/66; B67D 7/70; B67D 7/08; B65B 25/008; B65B 1/04; B65B 43/52; B65B 7/28; B65B 1/30; B65B 65/003

(57) ABSTRACT

An apparatus for dispensing a liquid into one or more cavities of one packaging shells for ophthalmic lenses, comprises a dispenser block, a dispenser head separate from the dispenser block. The apparatus further comprises one or more tubes connecting the dispenser block and the dispenser head. Additionally, the dispenser block comprises a reservoir for the liquid to be dispensed, and one or more dosing pumps for conveying the liquid from the reservoir to the dispenser head. The dispenser head comprises one or more dispensing tips detachably arranged on the dispenser head, each of the dispensing tips being in fluid communication with the dispenser block by a separate one of the one or more tubes.

This application claims the benefit under 35 USC 119(e) of the U.S. Provisional Patent Application No. 62/772,216 filed Nov. 28, 2018, incorporated herein by reference in its entirety.

### FIELD

The present invention relates to an apparatus for dispensing a liquid, in particular a saline solution, into one or more cavities of ophthalmic lens packaging shells, in particular contact lens packaging shells or intraocular lens packaging shells. The apparatus is particularly suitable for being used in an automated contact lens manufacturing line. The invention also relates to a packaging line for producing primary packages having a plurality of packaging stations and comprising such an apparatus for dispensing a liquid in at least one of the plurality of packaging stations.

### BACKGROUND

Hydrophilic ophthalmic contact lenses are commonly packaged in individual primary packages, generally known as “blister packages” or “blister packs.” A blister package generally comprises a plastic (e.g. polypropylene) shell having a concave or bowl-shaped depression or cavity in which a lens is disposed immersed in a sterile aqueous (saline) solution and which is closed by a laminate cover foil sealed to a flat rim surrounding the cavity. The blister packages are generally manufactured in strips comprising a number, such as five, of adjoining blister packages from which a user can easily separate one blister package by tearing the foil along scoring lines provided in the foil that connects the individual shells to form the strip. Such blister package keeps the lens in a hydrated and sterile state before being opened and worn by a user.

During production, a plurality of such packaging shells (e.g., five packaging shells) is carried in one carrier tray, and the carrier trays (each carrying five packaging shells) are moved from one station to the next by a conveyor. For purposes of clarity, however, the packaging process is described herein with respect to only one single lens and its package. At a contact lens placement station, the contact lens is placed into the cavity of the packaging shell. The packaging shell is then conveyed to a saline dosing station in which a predetermined amount of saline solution is dispensed into the cavity. The predetermined amount of saline solution is sufficient to ensure that the lens is completely immersed. In addition to water and sodium chloride, the saline solution may contain one or more additives, such as buffers and lubricating agents. After optical inspection of the lenses in an in-package inspection station, the packaging shell is conveyed to a foil placement station that places a foil cover on the upper surface of the packaging shell, and the foil is subsequently sealed to the rim of the packaging shell in a sealing station to form the completed blister package.

In the step of dispensing the predetermined amount of saline solution into the cavity of the packaging shell, a saline solution dispensing system is used which comprises a volumetric dosing system in which a predetermined volume of saline solution is dispensed into the cavity of the packaging shell through movement of a plunger within a cylinder. Moving the plunger for a predetermined distance within the cylinder displaces a predetermined volume of saline solution out of the dispensing tip of the cylinder and into the cavity of the packaging shell. In this dispensing system the supply channel for supplying the saline solution from a reservoir to the individual cylinder, the cylinder itself including the dispensing tip, and the plunger together form an individual dispensing block, with a plurality of (e.g. five) individual dispensing blocks being connected to one another to form an arrangement of connected dispensing blocks in a dispensing unit that is arranged above the carriers carrying the packaging shells. Also, the drives for moving the plungers of the individual dispensing blocks within the cylinders are arranged in the dispensing unit that is arranged above the carriers carrying the packaging shells. The remaining components of the dispensing system may be arranged in a frame laterally beside the conveying tracks of the packaging station along which the carriers carrying the shells are conveyed. In case a dispensing tip of a cylinder is getting clogged at least the complete block comprising the clogged dispensing tip, the supply channel and the plunger must be replaced. Clogging of a dispensing tip may happen, for example, in the event of crystallization of the salt contained in the saline solution.

It is therefore an object of the present invention to overcome the afore-discussed disadvantages of the prior art. Another object of the invention is to provide an apparatus for dispensing a liquid into cavities for ophthalmic lens packaging shells, for example for contact lenses like soft or hard contact lenses, or intraocular lenses, with high flexibility, which can be integrated into production lines while enhancing handling of the apparatus.

### SUMMARY OF THE INVENTION

To achieve the above-mentioned objects, the present invention suggests an apparatus as it is specified by the features of the independent claims. Advantageous aspects of the apparatus according to the invention are the subject matter of the dependent claims.

Throughout the entire specification including the appended claims, the singular forms “a”, “an”, and “the” include the plural, unless the context explicitly dictates otherwise. Also, whenever features are combined with the term “or”, the term “or” is to be understood to also include “and” unless it is evident from the specification that the term “or” must be understood as being exclusive.

In particular, the present invention suggests an apparatus for dispensing a liquid, in particular a saline solution, into one or more cavities of one or more packaging shells for ophthalmic lenses, comprising:

a dispenser block, a dispenser head separate from the dispenser block, the dispenser head being arranged spaced apart from the dispenser block, and
one or more tubes, in particular flexible tubes, connecting the dispenser block and the dispenser head,
wherein the dispenser block comprises a reservoir for the liquid to be dispensed, and one or more dosing pumps for conveying the liquid from the reservoir to the dispenser head,
and wherein the dispenser head comprises one or more dispensing tips detachably arranged on the dispenser head, each of the one or more dispensing tips being in fluid communication with the dispenser block by a separate one of the one or more tubes.

According to one aspect of the apparatus according to the invention, the apparatus further comprises one or more tip connectors which are fixedly arranged on the dispenser head, wherein each of the one or more dispensing tips is detachably mounted to a corresponding one of the one or more tip connectors, and wherein the dispensing tips and the tip connectors have fluid fittings forming a leakage-free connection between the respective dispenser tip and the corresponding tip connector when being connected with one another. The fluid fittings are in particular Luer taper connectors, and very particularly Luer lock fittings.

According to an additional aspect of the apparatus according to the invention, the one or more tip connectors are fixedly arranged on a connector rail arranged on the dispenser head.

According to a further aspect of the apparatus according to the invention, the one or more dosing pumps of the dispenser block are precision dosing pumps, in particular micro annular gear pumps.

According to still a further aspect of the apparatus according to the invention, the apparatus comprises a storage container pump, in particular a peristaltic pump, for conveying the liquid from a storage container to the reservoir.

According to yet another aspect of the apparatus according to the invention, the reservoir is sealed against leakage of liquid, and the reservoir comprises a pressure compensation pipe extending from the interior of the reservoir to the ambient environment for pressure compensation in the interior of the reservoir, the pressure compensation pipe comprising a sterile filter arranged therein for avoiding contamination of the liquid in the reservoir with foreign organic or inorganic matter by air passing through the pressure compensation pipe into the reservoir.

Still in accordance with another aspect of the apparatus according to the invention, the dispenser block comprises a first liquid level sensor for determining an operational liquid level in the reservoir.

In accordance with a further aspect of the apparatus according to the invention, the dispenser block further comprises a second liquid level sensor for determining a maximum liquid level in the reservoir to prevent overflow of the reservoir.

The liquid level sensors may in particular be embodied as optoelectronic sensors (for water) such as water molecular sensors, or may be embodied as capacitive sensors.

According to an additional aspect of the apparatus according to the invention, the apparatus further comprises a frame, with the first liquid level sensor and the second liquid level sensor being fixedly mounted to the frame, particularly outside of the reservoir.

According to a further aspect of the apparatus according to the invention, each of the one or more dispensing tips has a dispensing opening at the lower end of the dispensing tip, with the dispensing opening being arranged at the same level as the predetermined operational liquid level in the reservoir determined by the first liquid level sensor.

Yet in accordance with another aspect of the apparatus according to the invention, the apparatus further comprises a reservoir inlet pipe connected to a storage container and to the reservoir, and optionally further comprises a particle filter arranged in the reservoir inlet pipe to prevent particles from entering the reservoir when the liquid is transported from the storage container to the reservoir.

In still some additional aspect of the apparatus according to the invention, the apparatus further comprises a bubble sensor arranged at or in the reservoir inlet pipe for determining when the storage container is getting empty (warning signal).

According to an additional aspect of the apparatus according to the invention, each of the one or more dosing pumps comprises a controller configured to dispense a predetermined amount of liquid through the dispensing opening of the respective dispensing tip into the cavity of the packaging shell, and further configured to thereafter retract the liquid from the dispensing opening in the respective dispensing tip to a predetermined level above the respective dispensing opening to avoid unintentional spilling of liquid from the respective dispensing tip.

An additional aspect of the invention relates to a packaging line for producing primary ophthalmic lens packages comprising a packaging shell containing in a cavity thereof an ophthalmic lens immersed in a storage liquid, and a cover foil sealed to the packaging shell around the cavity, wherein the packaging line comprises a transport path for the packaging shells along which a plurality of packaging stations are arranged, a first packaging station for placing the ophthalmic lens into the cavity of the packaging shell, a second packaging station in which the storage liquid is dosed into the cavity of the packaging shell, and a third station in which the cover foil is placed onto the packaging shell and sealed to the packaging shell around the cavity, wherein the second packaging station comprises an apparatus according to the invention, with the separate dispenser head having the one or more dispensing tips attached thereto being arranged above the transport path while the dispensing block is arranged laterally adjacent to the transport path.

According to a further aspect of the packaging line for producing primary packages, the packaging line comprises a station upstream of the first packaging station, wherein in that station upstream of the first packaging station a part of the storage liquid is dosed into the cavity of the packaging shell prior to placing the ophthalmic lens into the cavity of the packaging shell. That station upstream of the first packaging station may also comprise an apparatus according to the invention. The remaining part of the storage liquid is then dosed into the cavity of the packaging shell at the second packaging station.

The afore-mentioned embodiments are practical embodiments of the apparatus according to the invention, in particular for dispensing a liquid into cavities for ophthalmic lens packaging shells, particularly for a hard or soft contact lens or an intraocular lens.

The apparatus according to the invention allows for a simple and effective repair or maintenance of the apparatus when a dispensing tip is clogged. The dispensing tip may be easily replaced without having to replace the complete dispensing block as opposed to the dispensing system known in the art.

Additionally, due to the very compact dispenser head the apparatus according to the invention needs only minimal space above the carrier trays carrying the shells. The dispenser block may, for example, be arranged laterally to the transport path of the production line (or packaging line) and only the dispenser head may be arranged above the transport path of the production line (or packaging line). The required small space above the transport path of the production line (or packaging line) allows for simple integration of the apparatus according to the invention into existing production lines (or packaging lines). This simple integration is of particular interest for production plant expansions.

Due to the reduced number of mechanical and electrical parts of the apparatus according to the invention compared to the dispensing system known in the art, the costs are lower. Additionally, the reduced number of parts enhances reliability of the apparatus. Moreover, the presence of many reusable parts which may easily be sterilized keeps the running costs at a lower level. In operation, only the dispensing tips may need to be exchanged if clogging or mechanical damage of the tips occurs. All other parts are of high endurance. Nonetheless, in case these parts need to be replaced the detachable design of the individual parts of the apparatus allow for replacement only of that part that needs to be replaced rather than of complete units.

Moreover, the present apparatus is suitable for a clean-in-place process allowing cleaning the interior surfaces of pipes, vessels, process equipment, filters and associated fittings, without disassembly. The advantage is that the cleaning is faster, less labor-intensive and more reliable than conventional cleaning of the individual parts. Autoclaving of the individual parts may be omitted and the cleaning may be carried out by flushing the system with an isopropanol solution or a hydrogen peroxide solution. After a predetermined exposure time, the apparatus is rinsed, particularly with the liquid to be dispensed, before filling it with the liquid actually to be dispensed into the cavities of the packaging shells.

By replacing the dispensing tips only when required—for example due to clogging—the use of detachable dispensing tips also simplifies their replacement and reduces down-time of the apparatus. The remaining parts of the apparatus, in particular the dosing pumps, need not be replaced and therefore, no laborious (re-)calibration of the apparatus is needed.

Additionally, the apparatus is very efficient and needs only a small amount of liquid to make the apparatus ready for operation, for example after fill-up of the apparatus, after cleaning of the apparatus, or when air bubbles are detected in the dispensing tip.

The use of the precision dosing pumps allows very reliable and reproducible dosing even of small volumes into the cavity of the packaging shell. In particular, a precision dosing pump is able to dispense up to 2000 μl (microliters), particularly from 50 μl to 1000 μl, in a time period of 2 seconds or less, particularly 1 second or less, with a tolerance of less than 10 μl, particularly less than 5 μl.

The advantage is a very accurate liquid volume present in the cavity of the packaging shell, thereby allowing enhanced detection of deviations during inspection by reducing the acceptable tolerances during weighing, for example. The use of the apparatus according to the invention allows for tolerances as low as 5 μl to 10 μl per dispensing cycle, whereas the apparatus known in the art has tolerances of up to 50 μl to 100 μl per dispensing cycle. Several dosing cycles may result in an addition of the individual volume deviations. It is to be noted that these deviations may occur in each cavity of a blister, and hence a blister with five packaging shells (five cavities) may lead to up to five times the volume deviation. Hence, the present apparatus allows for an improved error detection (e.g. in case no saline solution is dispensed into one of the cavities of the blister) during weighing of the blisters.

Additionally, such reliable and reproducible dosage of small amounts of liquids with very low volume deviation is required when additives need to be added, for example. Such additives are needed for coating, in particular for an “In Package Coating” (IPC) processes. The pipes connect the dispensing tips to the precision dosing pumps. The number of precision dosing pumps may be adapted to the number of cavities (or the number of packaging shells) arranged on one carrier. In case there are five cavities (five packaging shells) arranged on the carrier, five dosing pumps may be provided in this set-up. The head of the dispenser block may then have five locations for receiving the dosing pumps, or may have more than five locations (for example eight locations), in which case the locations exceeding five are sealed (no dosing pump is provided at these locations). Alternatively, dosing pumps may be provided at all locations (for example eight locations) and only five dosing pumps are in operation.

The use of a tip connector having a fluid fitting cooperating with a corresponding fluid fitting on the dispensing tip allows for an easy exchange of the dispensing tip and for a reliable connection to the dispenser block via piping, in particular a flexible pipe, for example ETFE (EthyleneTetraFluoroEthylene) tubes. The flexible ETFE tubes allow for movement of the tubes within the apparatus but are stiff enough so as to provide for an accurate dispensing volume by keeping the interior volume of the tube constant during operation (no tube expansion or contraction). The tip connector provides for a leakage-free connection between a male-taper fitting and its mating female-taper fitting. The use of Luer taper connectors for Luer lock fitting may be particularly advantageous.

For invariable dispensing conditions, the tip connectors are fixedly arranged on the dispenser head and the dispensing tips are detachably coupled to the tip connectors. The tip connectors form a guide such that the dispensing tips will always be arranged at the same position after replacement (in particular, the dispensing openings of the dispensing tips are arranged at the same height), so that (re-)calibration of the apparatus due to dispensing tip replacement can be avoided. Additionally, the positions of the dispensing openings above the cavities of the packaging shells are precisely maintained.

The dispenser block may comprise a storage container pump which conveys the liquid from a storage container to the reservoir. The storage container pump may be directly driven by a drive, in particular a servo-engine which is operated, for example, by a dispenser controller. A separate pump unit, such as a commercially available separate peristaltic pump unit, is not required in this configuration. Nonetheless, the storage container pump may be embodied as a peristaltic pump. Any other suitable pump may also be used as storage container pump. The direct integration of the storage container pump into the apparatus, in particular as part of the dispenser block, provides simple and effective incorporation of the storage container pump into the dispenser system with easy control via a dispenser controller, for example. No additional interface is needed in order to communicate with a separate storage container pump.

In order to reduce or avoid the formation of foam within the reservoir during pumping of liquid into the reservoir, the reservoir may comprise at its bottom an inlet cone specifically designed to reduce or avoid the formation of foam.

The dispenser block may be designed such that the reservoir is air-tight, and may have a pressure compensation pipe that is connected to the outside environment for pressure compensation during pumping operations. The pressure compensation pipe may comprise a sterile filter arranged therein through which the air passes to avoid contamination of the liquid in the reservoir by foreign matter such as foreign particles and microorganisms.

The dispenser block may comprise a first liquid level sensor for determining an operational level of the liquid in the reservoir. This first liquid level sensor allows to keep the liquid level in the reservoir constant at a predetermined operational level. As variations of the level of the liquid in the reservoir may have an influence on the accuracy of the volume of liquid dispensed into the cavities of the packaging shells, a constant liquid level (the operational level) in the reservoir leads to repeated accurate volume dosage being performed by the apparatus.

A second liquid level sensor is arranged above the first liquid level sensor at a higher level of the reservoir to determine a maximum liquid level in the reservoir and avoid overflow of the reservoir and wetting of the sterile filter.

The sensors may be embodied as optoelectronic sensors for water (sensitive to water) such as water molecular sensors, or may be embodied as capacitive sensors. However, they may also be sensors of a different type as long as such sensors are suitable for the determination of the liquid level in the reservoir. When an optoelectronic sensor is used, a light beam has to pass through the walls of the reservoir, and in this case the walls of the reservoir are made from a material which is transparent at least to the wavelength(s) of the light beam. For example, the walls of the reservoir may be made of polypropylene.

The body of the reservoir may be equipped with a thread such that the body of the reservoir may be connected to a cover lid of the reservoir through a threaded connection.

The dispensing opening of the dispensing tip—located at the side opposite to the fluid fitting of the dispensing tip—may be arranged at the same level as the predetermined operational liquid level in the reservoir determined by the first liquid level sensor. The hydrostatic pressure in the dispensing tip is then small and the arrangement avoids any spilling or retraction of the liquid to be dispensed (leading to dead volume in the tip), which could result in an inaccurate volume of liquid being dispensed into the cavities of the packaging shells.

In order to avoid uncontrolled drop formation at the dispensing opening of the dispensing tip, the apparatus may be configured (e.g. programmed) to retract a predetermined volume of liquid at the end of the dispensing cycle. The retraction of the liquid may be carried out by reversing the precision dosing pump.

The liquid level sensors may be fixedly mounted to a frame of the dispenser block of the apparatus, and very particularly they may be mounted to the frame outside of the reservoir. This arrangement has the advantage that the liquid level sensors will always be arranged at the same height, regardless of the reservoir actually used. For example, when a reservoir of larger size is installed, or after cleaning of the reservoir, no laborious (re-)calibration is required.

A particle filter in the reservoir inlet pipe through which filter the liquid passes before entering the reservoir avoids the introduction of foreign particles into the reservoir and functions as supplementary barrier. Particularly, the filter may have a pore size of 10 μm. The filter is particularly arranged at a position below the liquid level for avoiding additional foam formation. However, the particle filter may be omitted, in particular in case such filter tends to be contaminated with germs. The liquid contained in the storage container may in this case have been filtered before being introduced into the storage container.

The dispenser head is an individual part which is separate from the dispenser block, but the dispensing tips of the dispenser head are in fluid communication with the dispenser block. The dispenser head is arranged above the transport path of the production line (packaging line), whereas the dispenser block may be arranged laterally beside (or even) below the transport path of the packaging shells through the production line (packaging line). The advantage is that no movable parts of the apparatus are arranged above the transport path, and in particular above the packaging shells. Hence, the risk of introduction of foreign matter into the cavities or onto the packaging shells is greatly reduced.

A bubble sensor may be arranged at or in the reservoir inlet pipe, for determining when the storage container is getting empty and for forwarding an alarm signal to the controller of the production line (packaging line).

Further embodiments and advantages become apparent from the following description of detailed embodiments of the method and system according to the invention with the aid of the drawings.

It is to be noted, that every individual feature described herein as well as all combinations of two or more such features are possible as long as such features are not mutually exclusive or are otherwise technically incompatible.

### BRIEF DESCRIPTION OF THE DRAWINGS

Further details and advantages of the invention will become apparent from the following description of exemplary embodiments of the invention with the aid of the drawings, in which:

FIG. 1 schematically shows an apparatus according to one embodiment of the invention;

FIG. 2 shows a further embodiment of the apparatus according to the invention;

FIG. 3 is an enlarged view of the peristaltic pump and its drive (detail A of FIG. 2); and

FIG. 4 is an enlarged view of a Luer lock fitting between a dispenser tip and its corresponding tip connector.

### DETAILED DESCRIPTION

As used in this specification, the term “saline solution” comprises any type of saline solution in which the ophthalmic lens, in particular a contact lens, such as a soft contact lens, or an intraocular lens, may be immersed in the cavity of the lens packaging shell. Such saline solution generally involves a sodium chloride basis and may include additives such as buffers or lubricating agents.

A dosing cycle is the process of dispensing a volume of liquid in the cavity of the packaging shell. Several dosing cycles may occur, such as a first dosing cycle of saline solution and a second dosing cycle of saline solution. Another dosing scheme may be a dosing cycle of a saline solution and the dosing cycle of an additive solution.

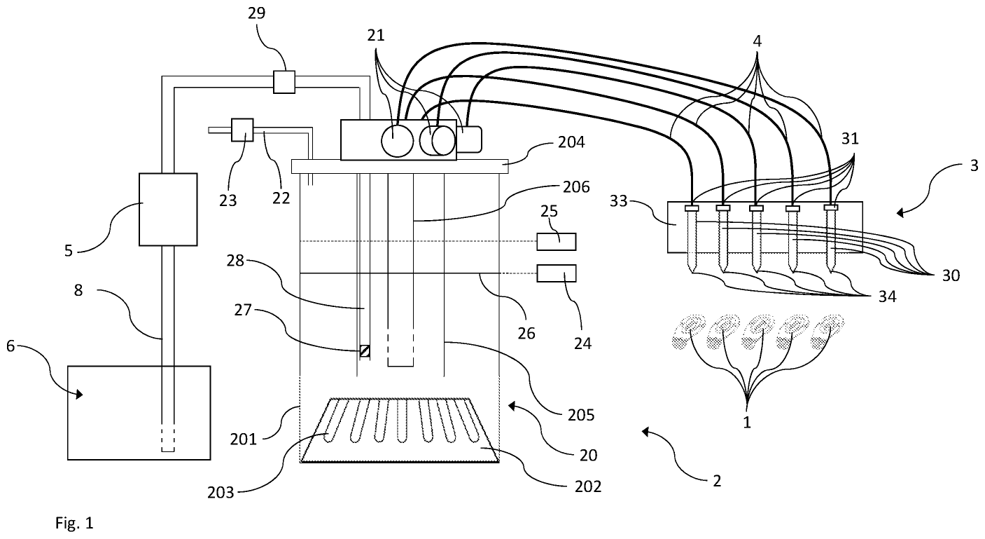

FIG. 1 shows schematically an apparatus according to the invention. The apparatus comprises a dispenser block 2 and a dispenser head 3. The dispenser block 2 comprises a frame (not shown in FIG. 1) to which reservoir 20 is attached. Reservoir 20 has a reservoir wall 201 made of transparent polypropylene. Reservoir 20 is closed at its bottom and comprises an inlet cone 202 having a structure 203 for reducing the formation of foam during conveyance of the saline solution into reservoir 20. At the top of reservoir 20, a cover lid 204 closes the reservoir 20 in an air-tight manner. Cover lid 204 of reservoir 20 comprises an inlet pipe 28, a pressure compensation pipe 22 and a pump block.

The inlet pipe 28 further comprises a particle filter 27 having a pore size of 10 μm and a bubble detector 29. The pressure compensation pipe 22 has a sterile filter 23 arranged therein to avoid the introduction of foreign matter into the reservoir 20 from the outside atmosphere.

The pump block comprises five dosing pumps 21 and a thick-walled tube 205 which extends into the liquid in the reservoir 20 and comprises an ascending pipe 206 in the inner volume of the thick-walled tube 205 and connected to the dosing pumps 21. The ascending pipe 206 has lateral openings arranged below the operational liquid level 26 for preventing any air bubbles to be conveyed to the dosing pumps 21 in the event air bubbles may reach the interior of the thick-walled tube 205. Air entrained in the liquid transported through the ascending pipe 206 would result in an incorrect volume of liquid being dispensed in to the cavities 1 of the packaging shells by the dispensing tips 30 of the dispenser head 3.

The dosing pumps 21 are of the type micro annular gear pump, and may for example be a micro annular gear pump of the type mzr-4665 M2.1, available from the company HNP Mikrosysteme GmbH, Schwerin, Germany. The apparatus comprising the dosing pumps 21 (micro annular gear pumps) may dispense volumes of 50 μl to 1000 μl with a tolerance of less than 5 μl into each of the cavities 1 of the packaging shells. By way of example, a pre-dosing of 200 μl saline solution may be performed before introducing the ophthalmic lens into the cavity 1, and a main dosing step of an additional 450 μl of saline solution may then be performed to complete the immersion of the ophthalmic lens in the saline solution.

The dispenser block 2 further comprises a first liquid level sensor 24 which may be an optoelectronic sensor sensitive to water (e.g. a water molecular sensor of the type BOH TJ-R010-008-01-S49F, available from the company Balluff AG, Bellmund, Germany). This first liquid level sensor 24 is for determining the operational level 26 of the liquid in the reservoir 20. The dispenser block further comprises a second liquid level sensor 25 (the second liquid level sensor 25 is of the same type as the first liquid level sensor 24) arranged above the first water molecular sensor 24. This second liquid level sensor 25 is for determining a maximum liquid level in the reservoir 20.

The dispenser block 2 further comprises a storage container pump embodied as a peristaltic pump 5 which is mounted to a frame of the dispenser block 2 and which is directly driven by a servo motor controlled by the apparatus. Saline solution is transported from a saline bag 6 into the interior of the reservoir 20 through a saline tube 8 (reservoir inlet pipe) by the peristaltic pump 5.

The dispenser head 3 in this embodiment comprises five dispensing tips 30, a corresponding number of tip connectors 31, and a connector rail 33. The tip connectors 31 are fixedly attached to the connector rail 33 and the dispenser tips 30 are attached to the tip connectors 31.

The dispensing tips 30 and the tip connectors 31 both have corresponding fluid fittings of the type Luer lock for leakage-free, reliable and detachable connection of the dispenser tips 30 to the tip connectors 31.

The tip connectors 31 are connected to the dosing pumps 21 (micro annular gear pumps) via flexible tubes 4. The dispensing tips 30 have dispensing openings 34 at their end opposite to the Luer lock fitting.

When a dispensing tip 30 is clogged or otherwise mechanically damaged, it may be easily exchanged by removing the dispensing tip (having the Luer lock fitting) from the tip connector 31. The new dispensing tip 30 is attached to the tip connector 31 via the Luer lock fitting. Accordingly, the apparatus is quickly ready for operation again after exchange of the dispenser tip 30 and does not require extended purging in order to remove any air present in the system.

The first liquid level sensor 24 ensures a constant saline solution level in the reservoir 20 during operation of the apparatus and keeps the hydrostatic pressure of the saline solution in the reservoir 20 constant for reliably dispensing reproducible dosing volumes into the cavities 1 of the packaging shells. In case the peristaltic pump 5 conveys an excess amount of saline solution from the storage container 6 into the reservoir 20, the second liquid level sensor 25 avoids overflow of the reservoir 20 which may otherwise lead to saline solution wetting the sterile filter 23.

The dispensing openings 34 of the dispensing tips 30 are arranged at the same level as the predetermined operation level 26 of liquid in the reservoir 20 as determined by the first liquid level sensor 24. The hydrostatic pressure then tends to zero and reduces undesirable saline solution conveyance and prevents any spilling or retraction of the liquid to be dispensed (leading to dead volume in the dispensing tip), which could result in incorrect volume dispensing into the cavities 1 of the packaging shells.

The bubble sensor 29 arranged at or in the reservoir inlet pipe 28 detects any air bubbles which may be entrained in the saline solution pumped by the peristaltic pump 5 in the event of an saline bag 6 getting empty, and generates a warning signal to the system (controller) indicating an upcoming saline bag exchange requirement.

During operation, the peristaltic pump 5 conveys saline solution from the saline bag 6 through the saline tube 8 into the reservoir 20. The peristaltic pump 5 is controlled such as to maintain a predetermined operational liquid level 26 with the aid of the first liquid level sensor 24 with an accuracy of less than 0.5 mm (millimeters) above or below the operational liquid level 26. To avoid overflow of the reservoir 20 the second liquid level sensor 25 determines whether the maximum liquid level is reached in the reservoir 20, and if this is the case it stops the peristaltic pump 5 from pumping further saline solution into the reservoir 20. The reservoir inlet pipe 28 leading into the reservoir comprises a particle filter 27 through which the saline solution passes while being pumped into the reservoir 20. The sterile filter 23 in the pressure compensation pipe allows pressure variations to be compensated while preventing any foreign organic or inorganic matter to enter the reservoir 20 and the saline solution contained therein.

The saline solution is transported from the reservoir 20 through the ascending pipe 206 arranged in the thick-walled tube 205 to the dosing pumps 21 (micro annular gear pumps) when these dosing pumps 21 (micro annular gear pumps) are operated to dispense saline solution into the cavities 1 of the packaging shells. The saline solution is drawn into the ascending pipe 206 via laterally arranged openings in the wall of the ascending pipe 206 to avoid aspiration of air bubbles which may possibly be contained in the interior of the thick-walled tube 205.

The dosing pumps 21 convey the saline solution through the tubes 4 to the dispensing tips 30. The dispensing openings 34 of the dispensing tips 30 are arranged above the cavities 1 of the packaging shells to fill the cavities 1 with the desired amount of saline solution.

Once the desired amount of saline solution has been dispensed into the cavities 1, the controller of the apparatus may reverse the dosing pumps 21 (micro annular gear pumps) to make them retract a very small predetermined volume of saline solution from the dispensing tip 30 in order to avoid any spilling of saline solution onto the packaging shell 1.

The tip connectors 31 are fixedly arranged on the connector rail 33 and the dispensing tips 30 are connected to the corresponding tip connectors 31 via Luer Lock fittings 301, 311 (see FIG. 4) so that they may be easily exchanged in the event of one or more clogged dispensing tips 30, while maintaining the exact position of the respective dispensing tip opening 34 over the respective cavity 1 of the respective packaging shell.

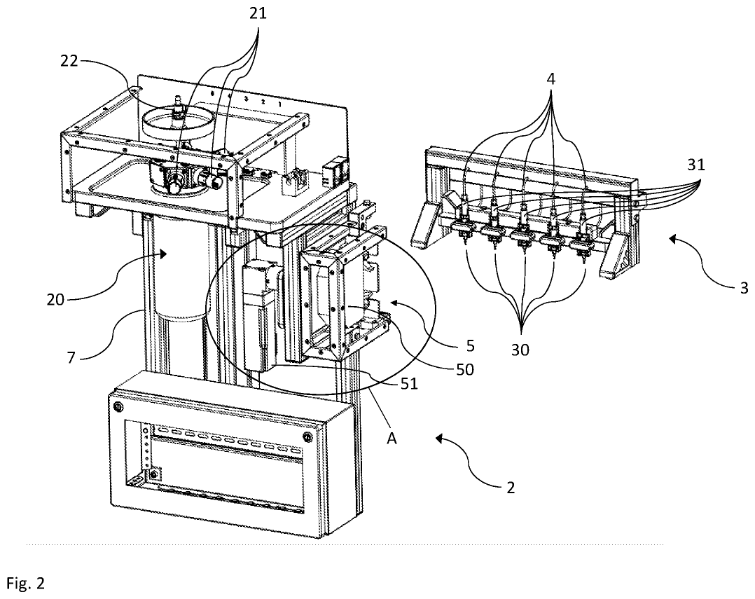

FIG. 2 shows an embodiment of the apparatus according to the invention. The dispenser head 3 is separate from the dispenser block 2, and is arranged spaced apart from the dispenser block 2 above the packaging shells (which are transported along a transport path through the various stations of the production line or packaging line). Dispenser block 2 comprises a frame 7 to which reservoir 20 is mounted. The cover lid 204 of reservoir 20 is fixedly attached to the frame 7 whereas the body of reservoir 20 is attached to the cover lid 204 via a threaded connection formed between the upper portion of the reservoir wall 201 and the cover lid 204. The peristaltic pump 5 and its pump head 50 and drive 51 are arranged on the frame 7 of dispenser block 2. The dispenser head 3 is separate from the dispenser block 2 and comprises a connector rail 33 on which the tip connectors 31 are fixedly arranged to which the dispensing tips 30 are connected. The tip connectors 31 and thus the dispensing tips 30 are in fluid communication with the dosing pumps 21 (micro annular gear pumps) via the flexible tubes 4.

The first liquid level sensor 24 (e.g. water molecular sensor, as discussed above) and the second liquid level sensor 25 (also a water molecular sensor, see above) are fixedly attached to the frame 7 of the dispenser block 2 and hence their mounting level is invariable. In the event of removing the reservoir 20 for cleaning, for example, or if the reservoir 20 is replaced with another reservoir 20, no laborious adjustment of the liquid level sensors 24 and 25 is required.

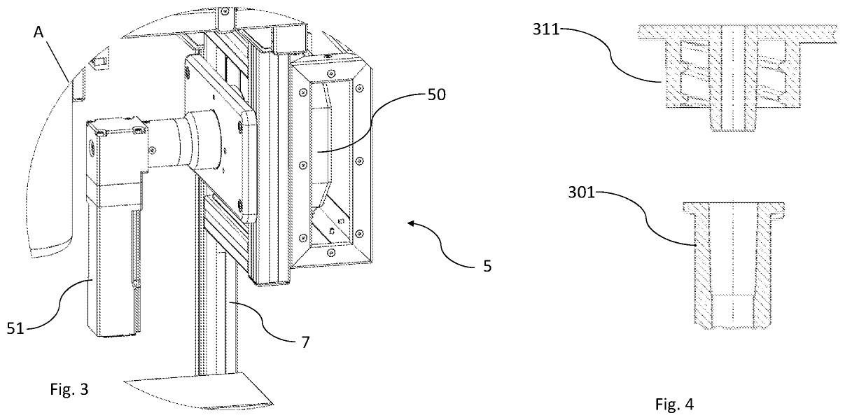

FIG. 3 (an enlargement of detail A in FIG. 2) shows the integration of the peristaltic pump 5 in the frame 7 of dispenser block 2. The peristaltic pump 5 comprises a peristaltic pump head 50 and a peristaltic pump drive 51. The peristaltic pump drive 51 is directly linked to the dispenser controller and does not need any additional interface for being operated and controlled. This allows for a simple and efficient integration of the peristaltic pump 5 in the apparatus as well as for a more accurate saline solution conveyance.

FIG. 4 shows a Luer lock system used for the connection of the dispenser tips 30 to the tip connectors 31. Each dispenser tip 30 has a female Luer lock fitting 301 which is designed to cooperate with a male Luer lock fitting 311 of the tip connector 31. The fitting is detachable to allow for an easy and reliable exchange of the dispensing tip 30. The Luer lock is a standardized system of small-scale fluid fittings used for making leakage-free connections between a male-taper fitting and its mating female fitting in medical and laboratory instruments.

The apparatus according to the invention can be used in a fully automated ophthalmic lens production process, such as, for example, a (soft) contact lens or intraocular lens production process. The apparatus is simple in construction and is capable of very accurately and reproducibly dispensing small liquid volumes into the cavities of packaging shells.

While embodiments of the invention have been described with the aid of the drawings, various changes, modifications, and alternatives are conceivable without departing from the teaching underlying the invention. Therefore, the invention is not intended to be limited to the described embodiments but rather is defined by the scope of the appended claims.

1. Apparatus for dispensing a liquid, in particular a saline solution, into one or more cavities (1) of one or more packaging shells for ophthalmic lenses, comprising:
a dispenser block (2),
a dispenser head (3) separate from the dispenser block (2), the dispenser head (3) being arranged spaced apart from the dispenser block (2), and
one or more tubes (4) connecting the dispenser block (2) and the dispenser head (3),
wherein the dispenser block (2) comprises a reservoir (20) for the liquid to be dispensed, and one or more dosing pumps (21) for conveying the liquid from the reservoir (20) to the dispenser head (3),
and wherein the dispenser head (3) comprises one or more dispensing tips (30) detachably arranged on the dispenser head (3), each of the one or more dispensing tips (30) being in fluid communication with the dispenser block (2) by a separate one of the one or more tubes (4).

2. Apparatus according to claim 1, further comprising one or more tip connectors (31) which are fixedly arranged on the dispenser head (3), wherein each of the one or more dispensing tips (30) is detachably mounted to a corresponding one of the one or more tip connectors (31), and wherein the dispensing tips (30) and the tip connectors (31) have fluid fittings forming a leakage-free connection between the respective dispenser tip (30) and the corresponding tip connector (31) when being connected with one another.

3. Apparatus according to claim 2, wherein the one or more tip connectors (31) are fixedly arranged on a connector rail (33) arranged on the dispenser head (3).

4. Apparatus according to claim 1, wherein the one or more dosing pumps of the dispenser block (2) are precision dosing pumps (21), in particular micro annular gear pumps.

5. Apparatus according to claim 1, further comprising a storage container pump (5), in particular a peristaltic pump, for conveying the liquid from a storage container (6) to the reservoir (20).

6. Apparatus according to claim 1, wherein the reservoir (20) is sealed against leakage of liquid, and wherein the reservoir (20) comprises an pressure compensation pipe (22) extending from the interior of the reservoir (20) to the ambient environment for pressure compensation in the interior of the reservoir (20), the pressure compensation pipe (22) comprising a sterile filter (23) arranged therein for avoiding contamination of the liquid in the reservoir (20) with foreign organic or inorganic matter by air passing through the pressure compensation pipe (22) into the reservoir (20).

7. Apparatus according to claim 1, wherein the dispenser block (2) comprises a first liquid level sensor (24) for determining an operational liquid level (26) in the reservoir (20).

8. Apparatus according to claim 7, wherein the dispenser block (2) further comprises a second liquid level sensor (25) for determining a maximum liquid level in the reservoir (20) to prevent overflow of the reservoir (20).

9. Apparatus according to claim 8, further comprising a frame (7), with the first liquid level sensor (24) and the second liquid level sensor (25) being fixedly mounted to the frame (7), particularly outside of the reservoir (20).

10. Apparatus according to claim 7, wherein each of the one or more dispensing tips (30) has a dispensing opening (34) at the lower end of the dispensing tip, with the dispensing opening (34) being arranged at the same level as the predetermined operation liquid level (26) in the reservoir (20) determined by the first liquid level sensor (24).

11. Apparatus according to claim 1, further comprising a reservoir inlet pipe (28) connected to a storage container (6) and to the reservoir (20), and further comprising a particle filter (27) arranged in the reservoir inlet pipe (28) to prevent particles from entering the reservoir (20) when the liquid is transported from the storage container (6) to the reservoir (20).

12. Apparatus according to claim 11, further comprising a bubble sensor (29) arranged at or in the reservoir inlet pipe (28) for determining when the storage container (6) is getting empty.

13. Apparatus according to claim 10, wherein each of the one or more dosing pumps (21) comprises a controller configured to dispense a predetermined amount of liquid through the dispensing opening (34) of the respective dispensing tip (30) into the cavity (1) of the packaging shell, and further configured to thereafter retract the liquid from the dispensing opening (34) in the respective dispensing tip (30) to a predetermined level above the respective dispensing opening (34) to avoid unintentional spilling of liquid from the respective dispensing tip (30).

14. Packaging line for producing primary ophthalmic lens packages comprising a packaging shell containing in a cavity (1) thereof an ophthalmic lens immersed in a storage liquid, and a cover foil sealed to the packaging shell around the cavity (1), wherein the packaging line comprises a transport path for the packaging shells along which a plurality of packaging stations are arranged, a first packaging station for placing the ophthalmic lens into the cavity (1) of the packaging shell, a second packaging station in which the storage liquid is dosed into the cavity (1) of the packaging shell, and a third station in which the cover foil is placed onto the packaging shell and sealed to the packaging shell around the cavity (1), wherein the second packaging station comprises an apparatus according to any one of the preceding claims, with the separate dispenser head (3) having the one or more dispensing tips (30) attached thereto being arranged above the transport path while the dispensing block (2) is arranged laterally adjacent to the transport path.
